(19) United States
(12) Patent Application Publication
(10) Pub. No.: US 2026/0297860 A1
(43) Pub. Date: Oct. 1, 2026

(54) ARTIFICIAL TURF INFILL MATERIAL

(71) Applicant: UPM-KYMMENE CORPORATION, Helsinki (FI)

(72) Inventors: Janak SAPKOTA, Helsinki (FI); Matti RISTOLAINEN, Helsinki (FI); Teemu POHJALAINEN, Helsinki (FI); Salla HILTUNEN, Helsinki (FI); Pasi VIRTANEN, Helsinki (FI); Harri KOSONEN, Helsinki (FI); Sakari MODIG, Helsinki (FI); Mikko LASSILA, Helsinki (FI)

(21) Appl. No.: 19/474,787

(22) PCT Filed: Apr. 10, 2024
(86) PCT No.: PCT/FI2024/050163

§ 371 Date: Oct. 13, 2025

(30) Foreign Application Priority Data
Apr. 11, 2023 (FI) 20235407

(51) Int. Cl. E01C 13/08; C08J 3/12; C08J 3/16; C08K 3/00

(52) U.S. Cl. CPC E01C 13/083; C08J 3/126; C08J 3/128; C08J 3/16; C08K 3/00; C08J 2301/02

(57) ABSTRACT

An artificial turf infill material is disclosed. The artificial turf infill material comprises cellulose-containing granules, pearls and/or beads.

### TECHNICAL FIELD

The present disclosure relates to an artificial turf infill material, to artificial turf, to a process for preparing the artificial turf infill material, and to a use of the artificial turf infill material and/or of the cellulose-containing granules, pearls and/or beads as an infill material for artificial turf.

### BACKGROUND

Field sports, such as football, are increasingly played on artificial turf surfaces. The artificial turf aims at reproducing the playing properties of natural grass, while simultaneously being more weather and wear resistant, as well as relatively easy to maintain. Artificial turf may typically contain a backing layer, artificial grass fibers attached to the backing layer, and infill material distributed on the backing layer between the grass fibers. The infill material is typically granular.

Currently, the infill material typically contains rubber granules, often prepared from recycled waste tyres. Such rubber granules are a significant environmental concern, as they are subject to wear and are washed into the environment as microplastics. The rubber granules may contain heavy metals and other components that may be carcinogenic. Long-term exposure to rubber infill materials may cause health issues, such as endocrine disruption. Further, rubber infill materials may absorb significant amounts of radiation and thereby render the turf too hot for players without watering.

Alternative artificial turf infill materials have been tested, but the alternatives typically have their own downsides and challenges.

### SUMMARY

An artificial turf infill material is disclosed. The artificial turf infill material may comprise cellulose-containing granules, pearls and/or beads.

A process for preparing an artificial turf infill material is disclosed. The artificial turf infill material may comprise cellulose-containing granules, pearls and/or beads. The process may comprise forming a solution comprising cellulose material dissolved in the solution into droplets and coagulating the droplets into cellulose-containing granules, pearls and/or beads.

Use of the artificial turf infill material and/or of the cellulose-containing granules, pearls and/or beads as an infill material for artificial turf is also disclosed.

### BRIEF DESCRIPTION OF THE DRAWINGS

The accompanying drawings, which are included to provide a further understanding of the embodiments and constitute a part of this specification, illustrate various embodiments. In the drawings:

FIG. 1A shows an embodiment of an artificial turf infill material;

FIG. 1B describes another embodiment of an artificial turf infill material;

FIG. 1C shows another embodiment of an artificial turf infill material;

FIG. 2 describes a schematic embodiment of an artificial turf;

FIG. 3 illustrates the biodegradability of cellulose-containing pearls;

FIG. 4 illustrates the morphology of cellulose pearls with different diameters;

FIG. 5 shows scanning electron microscopy of cellulose pearls with different surface profiles; and

FIG. 6 shows cellulose pearls with different size distributions.

### DETAILED DESCRIPTION

An artificial turf infill material is disclosed. The artificial turf infill material may comprise cellulose-containing granules, pearls and/or beads.

A process for preparing an artificial turf infill material is also disclosed. The artificial turf infill material may comprise cellulose-containing granules, pearls and/or beads. The cellulose-containing granules, pearls and/or beads may be cellulose-containing granules, pearls and/or beads according to one or more embodiments described in this specification.

The process may comprise forming, e.g. extruding, a solution comprising cellulose material dissolved in the solution into droplets and coagulating the droplets into cellulose-containing granules, pearls and/or beads.

The process may comprise forming, e.g. extruding, an alkaline cellulose dope into droplets, the alkaline cellulose dope comprising the cellulose material dispersed and dissolved in a cold alkaline solution, and coagulating the droplets into the cellulose-containing granules, pearls and/or beads.

The cellulose-containing granules, pearls and/or beads may comprise or be formed of a cellulose-based material.

The artificial turf infill material may be cellulose-based, so it may be bio-based or mainly bio-based. The artificial turf infill material may be relatively non-toxic and less harmful for humans and/or the environment than e.g. rubber granules.

The artificial turf infill material may be biodegradable. The artificial turf infill material may be biodegradable as determined by the standard OECD for testing of chemicals 301 F (Manometric respiratory test). In particular, embodiments in which the artificial turf infill material is formed of a cellulose material only may be biodegradable.

The biodegradable artificial turf infill material may be an artificial turf infill material for which at least 60% biodegradability is reached within 60 days as determined by the standard OECD for testing of chemicals 301 F.

The term “biodegradable” may, at least in some embodiments, refer to readily biodegradable as determined by the standard OECD for testing of chemicals 301 F (Manometric respiratory test). The readily biodegradable artificial turf infill material may be a artificial turf infill material for which at least 60% biodegradability is reached within 30 days as determined by the standard OECD for testing of chemicals 301 F.

The artificial turf infill material may be prepared such that it has desired physical properties. For example, the size and/or shape of the cellulose-containing granules, pearls and/or beads may be adjusted and selected such that desired properties for the artificial turf infill material are obtained. The surface properties of the cellulose-containing granules, pearls and/or beads may also be adjusted.

The cellulose content of the artificial turf infill material and/or of the cellulose-containing granules, pearls and/or beads may be at least 20% (w/w) based on the total dry weight of the artificial turf infill material and/or the total dry weight of the cellulose-containing granules, pearls and/or beads. In some embodiments, the cellulose content of the artificial turf infill material and/or of the cellulose-containing granules, pearls and/or beads may be at least 40% (w/w), at least 50% (w/w), or at least 60% (w/w), or at least 70% (w/w), or at least 80% (w/w), or at least 90% (w/w) based on the total dry weight of the artificial turf infill material and/or on the total dry weight of the cellulose-containing granules, pearls and/or beads.

The cellulose-containing granules, pearls and/or beads may be obtainable by forming, for example by extruding, a solution comprising cellulose material dissolved in the solution into droplets and coagulating the droplets into cellulose-containing granules, pearls and/or beads. In other words, droplets may be formed from the solution comprising the cellulose material dissolved in the solution. The droplets may then be coagulated into the cellulose-containing granules, pearls and/or beads.

The cellulose material may be obtainable or obtained e.g. from waste cellulose material and/or from a side stream of cellulose film making or of textile fiber spinning. Therefore material losses may be reduced or avoided, and profitability of the cellulose film making or of the textile fiber spinning processes may be improved.

The solution comprising cellulose material dissolved in the solution may be obtainable or obtained from various different processes, such as from a viscose, Lyocell, or ionic liquid process. The solution may comprise or be an alkaline cellulose dope comprising the cellulose material dispersed and dissolved in a cold alkaline solution

The cellulose-containing granules, pearls and/or beads may be obtainable by forming, e.g. extruding, an alkaline cellulose dope into droplets, the alkaline cellulose dope comprising the cellulose material dispersed and dissolved in a cold alkaline solution, and coagulating the droplets into the cellulose-containing granules, pearls and/or beads.

The solution comprising cellulose material dissolved in the solution, such as the alkaline cellulose dope, may be extruded e.g. through a die or a nozzle.

The droplets may also be formed by spin droplet formation (by feeding a liquid jet into a rotating blade), emulsifying or phase separation.

The viscosity of the solution, such as an alkaline cellulose dope, may be adjusted so as to be desirable for forming the droplets, e.g. by extrusion. The consistency of the alkaline cellulose dope may be e.g. in the range of 4-12 wt-%.

In the context of this specification, the term “droplet” may be understood as referring to a droplet of any shape, for example essentially spherical, spherical, essentially spheroidal, spheroidal, essentially tear-shaped and/or tear-shaped.

In the context of this specification, the term “alkaline cellulose dope” may be understood as a solution comprising cellulose solubilized in an alkaline solution. For example, the alkaline cellulose dope may be a cellulose spinning solution (i.e. an alkaline cellulose spinning solution) or a cellulose solution (i.e. alkaline cellulose solution) for extrusion, spinning, electrospinning, molding, casting, film forming, film extrusion, cellulose pearl production, coating, spraying and/or 3D printing. In other words, it may refer to cellulosic material in alkaline solution suitable for use e.g. in spinning filaments, staple fibers, film making, cellulose pearl production, and various other purposes. The cellulose alkaline cellulose dope may be coagulated in suitable conditions into solid cellulose, for example into type II cellulose.

Providing the cold alkaline solution may comprise mixing and/or dissolving an alkaline agent, such as NaOH, and optionally a dissolution or stabilizing agent, for example a zinc compound, such as ZnO, with water. They may be mixed at conditions suitable for dissolving the components in water, for example at an elevated temperature and such that the alkaline agent, such as NaOH, is added at a concentration of at least 40% (w/w). The elevated temperature may be e.g. a temperature of at least 60° C. The resulting alkaline solution may then be diluted.

The alkaline agent may comprise or be e.g. NaOH, LiOH, KOH, and/or any mixture or combination thereof. The alkaline agent may comprise or be e.g. NaOH, LiOH, and/or any mixture or combination thereof. Additional organic hydroxide may also be included in the cold alkaline solution, such as tetrabutylammonium hydroxide, etc. The cold alkaline solution may be an aqueous alkaline solution.

As a skilled person will understand, the zinc compound, such as ZnO, may be present in the alkaline cellulose dope and in the cold alkaline solution e.g. in the form of zincates. Solid zinc oxide may dissolve in alkaline solutions to give soluble zincates as shown in the exemplary equation below:

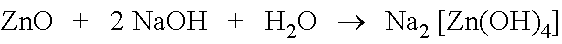

The cold alkaline solution may comprise the alkaline agent, such as NaOH, at a concentration in the range of about 5-9% (w/w), or about 6.5-8% (w/w).

The cold alkaline solution may further comprise about 0-3% (w/w), or 0.1-2.5% (w/w), or 0.5-1.3% (w/w) of the zinc compound, such as ZnO.

The cold alkaline solution may comprise ZnO and NaOH e.g. at a mass ratio in the range of 0.025-0.3.

The cellulose material may comprise cellulose and optionally hemicelluloses. Many sources of cellulose may additionally contain an amount of hemicelluloses. For example, pulp may comprise a mixture of cellulose and hemicelluloses. The cellulose material or the mixture may comprise e.g. at least 75% (w/w), or at least 80% (w/w), or at least 85% (w/w), or at least 90% (w/w), or at least 95% (w/w) of cellulose on the basis of the total dry weight of the cellulose material or of the mixture. The mixture may comprise e.g. at least 9% (w/w), or at least 13% (w/w), or at least 15% (w/w), or 10-23% (w/w), or 13-18% (w/w) of hemicelluloses on the basis of the total dry weight of the cellulose and hemicelluloses. The hemicelluloses may also be solubilized in the alkaline cellulose dope.

The cellulose material may comprise or be e.g. pulp. The pulp may be hydrolyzed pulp. The pulp may be alkaline soluble pulp.

The pulp may comprise or be e.g. wood pulp (such as hardwood and/or softwood pulp), non-wood pulp, and/or agropulp. The pulp may be chemical pulp, such as kraft pulp. The pulp may, additionally or alternatively, be never dried pulp, such as never dried kraft pulp. The cellulose material or the pulp may comprise or be recycled fiber.

The cellulose material prior to the dissolution may be in solid form, e.g. as dry pulp. Alternatively, it may be e.g. in the form of a slurry.

The cellulose material may be dispersed and dissolved in the cold alkaline solution e.g. by feeding the cellulose material and the cold alkaline solution into a continuous reactor or a high consistency dissolving unit in which partial or full dissolution of the cellulose of the cellulose material may be achieved.

The concentration of the dissolved cellulose in the alkaline cellulose dope may be at least 5% (w/w), or at least 7% (w/w), or at least 8% (w/w), or at least 9% (w/w), or at least 10% (w/w), or at least 11% (w/w), or at least 12% (w/w). The concentration of the dissolved cellulose in the alkaline cellulose dope may be in the range of about 4-12% (w/w).

The temperature of the cold alkaline solution may be e.g. in the range of −20 to 5° C., or in the range of −4 to 5° C. when dissolving the cellulose material and/or of the alkaline cellulose dope.

The cellulose of the alkaline cellulose dope may be considered to be coagulated and/or regenerated when the cellulose-containing granules, pearls and/or beads with a desired shape are obtained therefrom. The cellulose is not necessarily actually regenerated cellulose in the sense that it would have undergone the viscose process and subsequent regeneration. In this case, the terms “coagulated” and “regenerated” may refer to cellulose that is precipitated and/or crystallized from the solubilized state. It may be crystallized at least partially into cellulose II; or partially into cellulose I and partially into cellulose II. Typically, the coagulated cellulose, for example coagulated from an alkaline cellulose dope, is in the form of cellulose II.

The viscosity of the alkaline cellulose dope may be controlled, such that it may be formed, e.g extruded, into droplets. Additionally or alternatively, the degree of polymerization of the cellulose in the alkaline cellulose dope may be reduced, for example by hydrolysis.

The cellulose material, such as pulp, may be pre-treated, for example by a mechanical pre-treatment (up to 5 h) followed by a 2-3-h enzymatic hydrolysis utilizing cellulolytic enzymes.

The CED viscosity of the alkaline cellulose dope may be in the range of 100-500 ml/g. The CED viscosity of the alkaline cellulose dope may be in the range of 140-200 ml/g, or in the range of 150-170 ml/g. The term “CED viscosity” may be understood as referring to viscosity number in cupri-ethylenediamine (CED) solution. Cellulose material with a relatively low CED viscosity may have better solubility and may therefore allow for obtaining an alkaline cellulose dope with a higher concentration of the dissolved cellulose in the alkaline cellulose dope and/or a more stable alkaline cellulose dope. The CED viscosity may be measured e.g. according to the standard ISO 5351:2010.

The mean diameter and/or the median diameter of the cellulose-containing granules, pearls and/or beads may be in the range of 0.02 to 6 mm, or in the range of 1 to 3 mm.

The mean diameter and/or the median diameter of the cellulose-containing granules, pearls and/or beads and/or the distribution thereof may be measured e.g. using a particle size analyser (for example, an Anton Paar PSA 1190 device) with a dry sample measurement using the freefall method. In the freefall method, the sample may be set in motion by vibrating it with the selected force and frequency, causing it to drop past the lasers of the measurement unit of the particle size analyser as a free fall. Vibration duty cycle of 65% and vibrator frequency of 68 Hz may be used for the measurements with Anton Paar PSA 1190 device in dry freefall mode.

The term “mean diameter” may be understood as referring to the mean value of all diameters in the sample. The term “mean diameter” may, in the context of this specification, refer to volume mean diameter.

The term “median diameter” may refer to the midpoint of diameters when all diameters in the sample are arranged in the order of value, i.e. there are equally many higher and lower values. The term “median diameter” or “D50” may, in the context of this specification, refer to volume median diameter.

The distribution of the diameters of the cellulose-containing granules, pearls and/or beads may be broad or narrow.

For example, at least 90% of the cellulose-containing granules, pearls and/or beads may have a diameter in the range of 0.02 to 6 mm, or in the range of 1 to 3 mm. In some embodiments, at least 90% of the cellulose-containing granules, pearls and/or beads may have a diameter in the range of 0.9 to 2 mm. In some embodiments, at least 90% of the cellulose-containing granules, pearls and/or beads may have a diameter in the range of 0.5 to 1.5 mm. In some embodiments, the median (D50) volume of the cellulose-containing granules, pearls and/or beads may be in the range of 1 to 2 mm.

The artificial turf infill material may further comprise an inorganic material, such as at least one of sand, chalk, quartz, brick dust, charcoal, calcium carbonate, or kaolin. The inorganic material may be considered to be a filler. The presence of the inorganic material may have an effect on the biodegradability of the artificial turf infill material. Such embodiments may not necessarily be biodegradable or fully biodegradable. However, some such embodiments may be biodegradable, e.g. readily biodegradable as set out above in this specification. The cellulose content of the artificial turf infill material and/or of the cellulose-containing granules, pearls and/or beads may naturally depend on the content of the inorganic material.

The process may comprise mixing the inorganic material with the solution comprising cellulose material dissolved in the solution, such as the alkaline cellulose solution before forming the alkaline cellulose dope, forming (e.g. extruding) the solution, such as the alkaline cellulose dope, into droplets, the solution such as alkaline cellulose dope comprising the cellulose material dispersed and dissolved in a cold alkaline solution, and coagulating the droplets into the cellulose-containing granules, pearls and/or beads encapsulating the inorganic material.

Alternatively, the process may comprise forming the inorganic material into granules of a desired size (or diameter), for example by extruding, and coating the granules with a solution comprising cellulose material dissolved in the solution, such as an alkaline cellulose dope.

The inorganic material may be encapsulated in the cellulose-containing granules, pearls and/or beads. In other words, the cellulose-containing granules, pearls and/or beads may comprise a core of the inorganic material. The core of the inorganic material may be at least partially or completely covered by the cellulose-containing material. Such cellulose-containing granules, pearls and/or beads may be obtainable or obtained e.g. by mixing the inorganic material with the solution comprising cellulose material dissolved in the solution, such as the alkaline cellulose solution before forming the alkaline cellulose dope, forming the solution, such as the alkaline cellulose dope, into droplets, the solution such as alkaline cellulose dope comprising the cellulose material dispersed and dissolved in a cold alkaline solution and the inorganic material dispersed in the cold alkaline solution, and coagulating the droplets into the cellulose-containing granules, pearls and/or beads encapsulating the inorganic material. Such cellulose-containing granules, pearls and/or beads may be obtainable or obtained e.g. by mixing the inorganic material with the alkaline cellulose dope, forming the solution, such as the alkaline cellulose dope, into droplets, the solution such as alkaline cellulose dope comprising the cellulose material dispersed and dissolved and the inorganic material dispersed in the cold alkaline solution, and coagulating the droplets into the cellulose-containing granules, pearls and/or beads encapsulating the inorganic material. Alternatively, such cellulose-containing granules, pearls and/or beads may be obtainable or obtained e.g. by extruding or otherwise forming the inorganic material into granules of a desired size (or diameter) and coating them with the solution comprising cellulose material dissolved in the solution, such as the alkaline cellulose dope.

The shape(s) of the cellulose-containing granules, pearls and/or beads is/are not particularly limited; they may in principle have any shape. The cellulose-containing granules, pearls and/or beads may be, for example, essentially spherical, essentially spheroidal, and/or essentially tear-shaped. The cellulose-containing granules, pearls and/or beads may have a distribution of different shapes. The shape may be affected e.g. by the selection of the die used to extrude the solution comprising cellulose material, such as the alkaline cellulose dope, or by other features of the process for forming the droplets, such as the composition of the coagulation bath in which the droplets are coagulated cellulose-containing granules, pearls and/or beads.

The cellulose-containing granules, pearls and/or beads may be coagulated from the droplets after forming of the droplets and washed. For example, the method may comprise immersing the droplets in a coagulation bath (or one or more coagulation baths). The coagulation bath may contain a coagulation solution, which then may assist in coagulating the cellulose contained in the cellulose-containing granules, pearls and/or beads. The coagulation bath may be an acidic coagulation bath, such as a sulphuric acid bath. However, in some embodiments, the coagulation bath may comprise or be e.g. water or a mildly alkaline bath.

The cellulose-containing granules, pearls and/or beads may be washed after they have been coagulated. The formed cellulose-containing granules, pearls and/or beads may be immersed in one or more washing baths. For example, after a coagulation bath containing an acidic coagulation solution, the formed (e.g. extruded) cellulose-containing granules, pearls and/or beads may be immersed in one or more washing baths. Such washing baths could comprise e.g. water or another neutral solution.

The droplets may be coagulated in a coagulation bath comprising sodium metasilicate, sulphuric acid, acetic acid, an aqueous alcohol (such as ethanol and/or isopropanol), and/or or water at a temperature of at least 40° C.

The surface texture and/or other properties of the cellulose-containing granules, pearls and/or beads may be controlled or adjusted by the selection of the coagulation bath. When the coagulation bath comprises sulphuric acid, the surface of the cellulose-containing granules, pearls and/or beads may be relatively rough, and/or the shape of the cellulose-containing granules, pearls and/or beads may be essentially spherical or essentially spheroidal. When the coagulation bath comprises acetic acid, the surface of the cellulose-containing granules, pearls and/or beads may be relatively rough (although less rough than in a coagulation bath comprising sulphuric acid), and/or the shape of the cellulose-containing granules, pearls and/or beads may be essentially spherical or essentially spheroidal. When the coagulation bath comprises sodium metasilicate, the surface of the cellulose-containing granules, pearls and/or beads may be relatively smooth, and/or the shape of the cellulose-containing granules, pearls and/or beads may be more irregular.

The concentration of the sodium metasilicate in the coagulation bath may be e.g. in the range of about 0-15% (w/w), or about 0.1-15% (w/w).

The concentration of the sulphuric acid in the coagulation bath may be e.g. in the range of about 0.5-10% (w/w).

The concentration of the acetic acid in the coagulation bath may be e.g. in the range of about 0.5-10% (w/w).

The cellulose-containing granules, pearls and/or beads may be rough or smooth.

The cellulose-containing granules, pearls and/or beads may be hollow or solid (i.e. solid throughout). Hollow cellulose-containing granules, pearls and/or beads may be formed e.g. by extruding and coagulating droplets that are hollow.

The colour of the cellulose-containing granules, pearls and/or beads may be selected e.g. so as to achieve desired heat insulation properties or to reflect sunlight to a desired extent.

The cellulose-containing granules, pearls and/or beads may further comprise a coating. The coating may comprise or consist of e.g. a wax, alkyl ketene dimer, a fatty acid, a biopolymer, and/or an inorganic coating, such as silicate. The coating may e.g. reduce wetting of the artificial turf infill material.

The artificial turf infill material and/or the cellulose-containing granules, pearls and/or beads may be elastic.

In an embodiment, the artificial turf infill material does not comprise any plastic material.

Artificial turf is also disclosed. The artificial turf may comprise the artificial turf infill material according to one or more embodiments described in this specification.

The artificial turf may be an artificial turf for a sports field, for landscaping, and/or for yard lawn.

The artificial turf may comprise a backing layer, artificial grass fibers attached to the backing layer, and the artificial turf infill material distributed on the backing layer between the artificial grass fibers.

However, various types of artificial turf may be contemplated, and other structures may be possible.

Use of the artificial turf infill material and/or of the cellulose-containing granules, pearls and/or beads according to one or more embodiments described in this specification as an infill material for artificial turf is also disclosed.

In the context of the process, the artificial turf, and the use of the artificial turf infill material, the artificial turf infill material may be any artificial turf infill material according to one or more embodiments described in this specification.

### EXAMPLES

Reference will now be made in detail to various embodiments, an example of which is illustrated in the accompanying drawing.

The description below discloses some embodiments in such a detail that a person skilled in the art is able to utilize the embodiments based on the disclosure. Not all steps or features of the embodiments are discussed in detail, as many of the steps or features will be obvious for the person skilled in the art based on this specification.

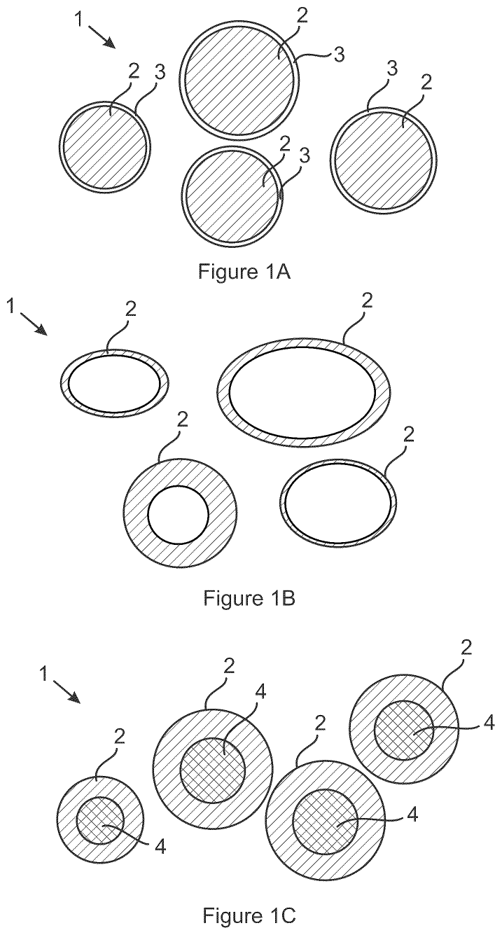

FIG. 1A describes an embodiment of an artificial turf infill material 1. In this schematic illustration, the artificial turf infill material 1 comprises cellulose-containing granules, pearls and/or beads 2, which are essentially spherical. In this exemplary embodiment, the cellulose-containing granules, pearls and/or beads 2 are solid. The cellulose-containing granules, pearls and/or beads 2 further comprise a coating 3, for example a coating comprising or formed of a wax, alkyl ketene dimer, a fatty acid, a biopolymer, and/or an inorganic coating, such as silicate. The coating 3 may be water resistant or repellent and/or impermeable to water. The coating 3 may be in the form of a coating layer. The coating 3 may cover the cellulose-containing granules, pearls and/or beads 2 at least partially, or it may completely cover the cellulose-containing granules, pearls and/or beads 2.

FIG. 1B describes another embodiment of an artificial turf infill material 1. In this schematic illustration, the artificial turf infill material 1 comprises cellulose-containing granules, pearls and/or beads 2, which are a mixture of essentially spherical or essentially spheroidal cellulose-containing granules, pearls and/or beads. However, the cellulose-containing granules, pearls and/or beads 2 could, additionally or alternatively, have any other shape, for example any shape described in this specification. The cellulose-containing granules, pearls and/or beads 2 in this embodiment are hollow, although they might in other embodiments be solid. The thickness of the wall of the individual cellulose-containing granules, pearls and/or beads 2 may vary, as shown in this schematic.

FIG. 1C describes another embodiment of an artificial turf infill material 1. In this schematic illustration, the artificial turf infill material 1 comprises cellulose-containing granules, pearls and/or beads 2, each of which comprises a core of an inorganic material 4, for example of sand, chalk, quartz, brick dust, charcoal, calcium carbonate, or kaolin. The core of the inorganic material 4 (e.g. a granule of the inorganic material 4) is covered and encapsulated by the cellulose-containing material. Although in this embodiment the cellulose-containing granules, pearls and/or beads 2 are essentially spherical, the cellulose-containing granules, pearls and/or beads 2 could, additionally or alternatively, have any other shape, for axample any shape described in this specification.

As a skilled person will understand, the coating 3 depicted in FIG. 1A could be included in the cellulose-containing granules, pearls and/or beads 2 described in any one of FIGS. 1B and 1C.

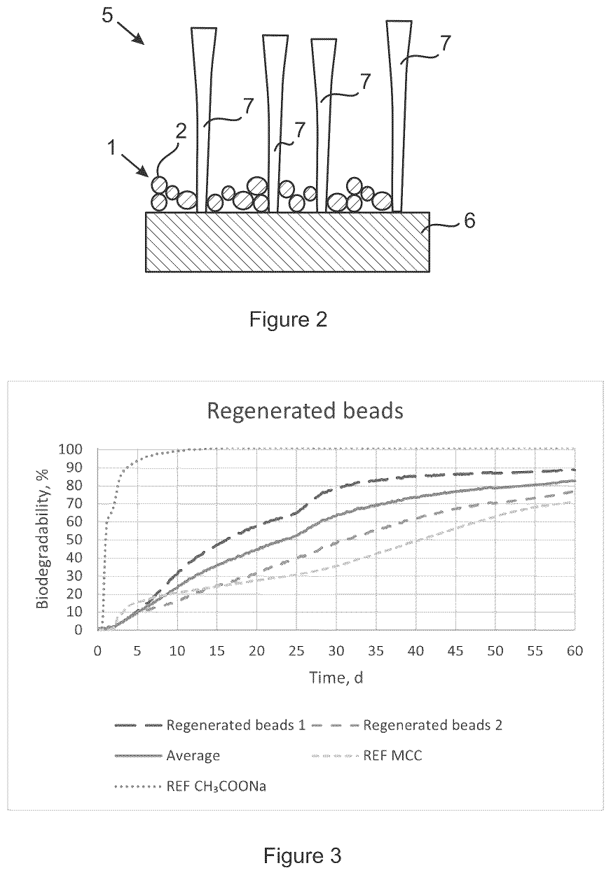

FIG. 2 describes a schematic embodiment of an artificial turf 5. The artificial turf 5 comprises a backing layer 6 and artificial grass fibers 7 attached to the backing layer 6. The artificial turf 5 further comprises an artificial turf infill material 1 distributed on the backing layer 6 between the artificial grass fibers 7. The artificial turf infill material 1 may be any artificial turf infill material described in this specification, and the cellulose-containing granules, pearls and/or beads 2 may be any cellulose-containing granules, pearls and/or beads 2 described in this specification.

### Example 1

Hydrolyzed softwood kraft pulp was used in the example, the pulp being characterized by an average polymerization degree of DP=380 determined by the viscosity measurements and dry matter content of ca. 75%. A mixture of 10.2% sodium hydroxide and 1.3% zinc oxide in water was used as a solvent to dissolve said pretreated pulp. Initial homogenization of said pulp was carried out with kitchen blender and the pulp was cooled down to near 0° C. prior the dissolution. Dissolution was carried out with laboratory mixer (DIAF), set at temperature range between −4 and 0° C. and stirring was done with constant frequency at 450 rpm. The quality of dissolution was evaluated based on the reference optical microscopy images of similar standard dope. To ensure quality in dope flow, dope was filtered through 400 μm and/or 100 μm textile filter wires. Thus, filtered dope was stored in closed container at 5° C. This was then coagulated in a spin bath containing different strong acids as elaborated in Table 1 to give precipitated beads. Size distributions of the cellulose-containing pearls coagulated in different coagulation baths were measured from dry samples in freefall mode using an Anton Paar PSA 1190 particle size analyser. The sample was set in motion by vibrating it with the selected force and frequency, causing it to drop past the lasers of the measurement unit as a free fall. Vibration duty cycle of 65% and vibrator frequency of 68 Hz was used for the measurements with the Anton Paar PSA 1190 device in dry freefall mode.

TABLE 1
Size distributions of cellulose-containing pearls coagulated in
different coagulation baths measured from dry samples in freefall
mode using an Anton Paar PSA 1190 particle size analyser.

| | | | |
|---|---|---|---|
| Time: | | | |
| Measurement | Sulphuric | Phosphoric | Phosphoric |
| name: | Acid | Acid | Acid II |
| Obscuration | 2.38 | 2.50 | 1.64 |
| (%): | | | |
| Mean size | 1485.77 | 1478.18 | 1473.07 |
| volume (μm) | | | |
| Mean size | 1418.36 | 569.69 | 1389.50 |
| surface (μm) | | | |
| Mean size | 326.63 | 0.87 | 233.20 |
| number (μm) | | | |
| Median, D50 | 1407.03 | 1392.01 | 1389.25 |
| volume (μm) | | | |

| | | |
|---|---|---|
| Time: | | |
| Measurement | Sulphuric Acid | Phosphoric |
| name: | batch II | Acid-Needles |
| | | II |
| Obscuration | 1.40 | 1.15 |
| (%): | | |
| Mean size | 1524.24 | 1464.31 |
| volume (μm) | | |
| Mean size | 571.82 | 694.92 |
| surface (μm) | | |
| Mean size | 0.55 | 1.24 |
| number (μm) | | |
| Median, D50 | 1452.23 | 1384.26 |
| volume (μm) | | |

### Example 2

The biodegradability of cellulose-containing pearls prepared as described in Example 1 was tested in aerobic aqueous medium according to QEOD guideline for testing of chemicals 301 F. Biological oxygen demand (BOD) is measured by manometric respirometry test using OxiTop-measurement system. BOD was then compared to theoretical (ThOD). CH₃COONa and microcrystalline cellulose (MCC) were used as reference materials.

The results are shown in FIG. 3.

### Example 3

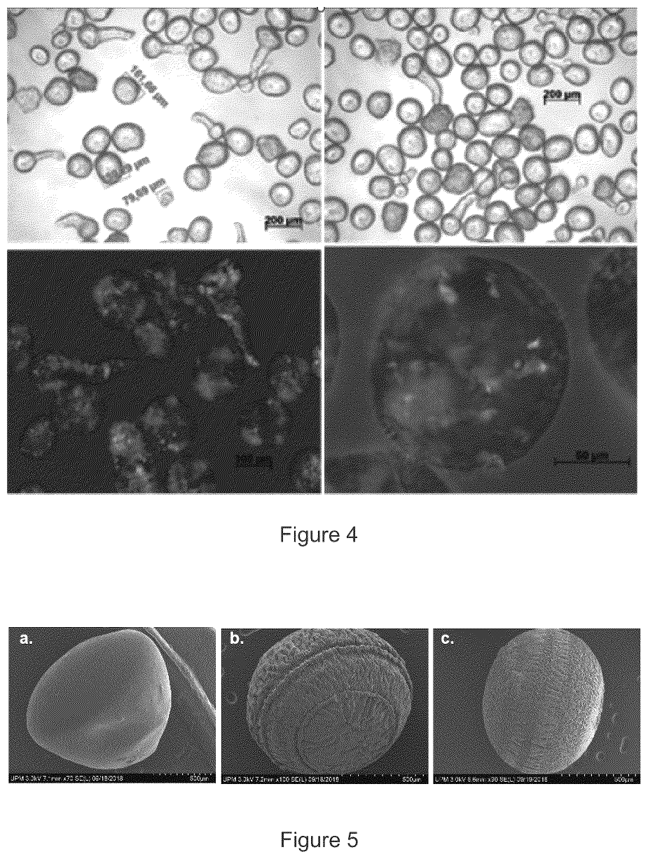

FIG. 4 illustrates the morphology of cellulose pearls with different diameters as indicated. Tear shaped pearls were coagulated/precipitated in 12 wt % metasilicate water solution, whereas spherical pearls were coagulated/precipitated in 10 wt % sulphuric acid water solution. The images in the lower row shows images with polarized optical microscopy—lighter color representing the crystallinity in pearls.

FIG. 5 shows scanning electron microscopy of cellulose pearls with different surface profiles. From left to right: pearls produced using a) metasilicate, b) sulphuric acid and c) acetic acid in the coagulation bath, respectively.

### Example 4

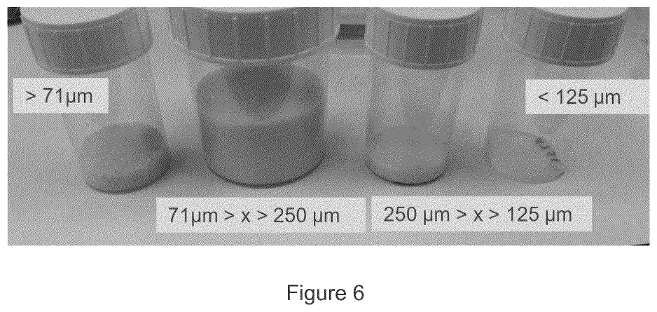

FIG. 6 shows cellulose pearls with different size distributions as indicated.

It is obvious to a person skilled in the art that with the advancement of technology, the basic idea may be implemented in various ways. The embodiments are thus not limited to the examples described above; instead they may vary within the scope of the claims.

The embodiments described hereinbefore may be used in any combination with each other. Several of the embodiments may be combined together to form a further embodiment. A process, a product, or a use, disclosed herein, may comprise at least one of the embodiments described hereinbefore. It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items. The term “comprising” is used in this specification to mean including the feature(s) or act(s) followed thereafter, without excluding the presence of one or more additional features or acts.

1. An artificial turf infill material, wherein the artificial turf infill material comprises cellulose-containing granules, pearls and/or beads.

2. The artificial turf infill material according to claim 1, wherein the artificial turf infill material is biodegradable as determined by the standard OECD for testing of chemicals 301 F.

3. The artificial turf infill material according to claim 1, wherein the cellulose content of the artificial turf infill material and/or of the cellulose-containing granules, pearls and/or beads is at least 20% (w/w) on the total dry weight of the artificial turf infill material and/or the total dry weight of the cellulose-containing granules, pearls and/or beads.

4. The artificial turf infill material according to claim 1, wherein the cellulose-containing granules, pearls and/or beads are obtainable by forming a solution comprising cellulose material dissolved in the solution into droplets and coagulating the droplets into cellulose-containing granules, pearls and/or beads.

5. The artificial turf infill material according to claim 1, wherein the cellulose-containing granules, pearls and/or beads are obtainable by forming an alkaline cellulose dope into droplets, the alkaline cellulose dope comprising the cellulose material dispersed and dissolved in a cold alkaline solution, and coagulating the droplets into the cellulose-containing granules, pearls and/or beads.

6. The artificial turf infill material according to claim 5, wherein the CED viscosity of the alkaline cellulose dope is in the range of 100-500 ml/g.

7. The artificial turf infill material according to claim 1, wherein the mean diameter and/or the median diameter of the cellulose-containing granules, pearls and/or beads is in the range of 0.02 to 6 mm, or in the range of 1 to 3 mm.

8. The artificial turf infill material according to claim 1, wherein the artificial turf infill material further comprises an inorganic material, such as at least one of sand, chalk, quartz, brick dust, charcoal, calcium carbonate, or kaolin.

9. The artificial turf infill material according to claim 1, wherein the droplets are coagulated in a coagulation bath comprising sodium metasilicate, sulphuric acid, acetic acid, an aqueous alcohol, or water at a temperature of at least 40° C.

10. The artificial turf infill material according to claim 1, wherein the cellulose-containing granules, pearls and/or beads are essentially spherical, essentially spheroidal, and/or essentially tear-shaped; and/or wherein the cellulose-containing granules, pearls and/or beads are hollow or solid.

11. The artificial turf infill material according to claim 1, wherein the cellulose-containing granules, pearls and/or beads further comprise a coating, wherein the coating optionally comprises a wax, alkyl ketene dimer, a fatty acid, a biopolymer, and/or an inorganic coating.

12. A process for preparing an artificial turf infill material, wherein the artificial turf infill material comprises cellulose-containing granules, pearls and/or beads, the process comprising forming a solution comprising cellulose material dissolved in the solution into droplets and coagulating the droplets into cellulose-containing granules, pearls and/or beads.

13. The process according to claim 12, wherein the process comprises forming an alkaline cellulose dope into droplets, the alkaline cellulose dope comprising the cellulose material dispersed and dissolved in a cold alkaline solution, and coagulating the droplets into the cellulose-containing granules, pearls and/or beads.

14. The process according to claim 13, wherein the CED viscosity of the alkaline cellulose dope is in the range of 100-500 ml/g.

15. Artificial turf comprising the artificial turf infill material according to claim 1.

16. Use of the artificial turf infill material according to claim 1 as an infill material for artificial turf.
